(19) United States
(12) Patent Application Publication
(10) Pub. No.: US 2008/0082292 A1
(43) Pub. Date: Apr. 3, 2008

(54) Method for contracting transportation

(76) Inventor: Thomas W. Storm, Casselberry, FL (US)

Correspondence Address: Paul S. Rooy;Registered Patent Attorney, 2620 South Peninsula Drive, Daytona Beach, FL, 32118, US

(21) Appl. No.: 11/901,737

(22) Filed: Sep. 19, 2007

Related U.S. Application Data
(60) Provisional application No. 60/848,875, filed on Oct. 3, 2006.

(51) Int. Cl. G06Q 40/00; G01B 11/02; G06F 17/00

(52) U.S. Cl. 702/156; 705/37

(57) ABSTRACT

A method for contracting transportation. A contractor uses scanning apparatus to accurately determine the volume of objects to be moved, and sends out contractor requests for quotation to a large number of moving companies. The contractor forwards the resulting moving company quotes to the customer, who communicates the winning quote to the contractor. The contractor may perform the transportation work himself for the winning quote price. In the alternative, the contractor may award the work to the moving company which supplied the winning quote, in which case the winning moving company remits a commission to the contractor for procuring the transportation work for the winning moving company.

### CLAIM OF PRIORITY

This utility patent application is based upon and claims the benefit of the earlier filing date of U.S. provisional patent application Ser. No. 60/848,875 filed Oct. 3, 2006 entitled Method for Contracting Transportation.

### BACKGROUND OF THE INVENTION

1. Field of the Invention

This invention relates to transportation of objects, and in particular to a Method for Contracting Transportation.

2. Background of the Invention

Cost estimates in the moving industry have traditionally relied on mechanical surveys conducted by moving company representatives. A customer may have three or more moving companies send their representatives to conduct three or more separate mechanical surveys. Each moving company, representative then communicates the mechanical survey results to the moving company, which in turn generates a cost estimate based on the survey results. The customer generally contracts the move to the company offering the best deal.

There are a number of problems associated with this traditional approach. One problem is the time wasted in conducting three or more independent mechanical surveys. The non-winning surveys represent wasted time on the part of the non-winning companies. The time the customer spends interacting with the non-winning companies is likewise a waste of time on the customer's part.

Another problem is the inherent inaccuracy of current mechanical survey methods. These surveys are more “guesstimates” than scientific measurements of volume, because the mechanical surveyor generally “eyeballs” the objects to be moved, and makes an educated guess as to what the total volume may be. The U.S. Statistical Abstracts publication estimates that as much as 20% of all household moving goods estimates are off by at least 10%!

Thus, it would be desirable to provide a method of contracting transportation in which only a single, accurate estimate is made using highly accurate apparatus and method for measuring volume. This would overcome the inherent inaccuracies of current eyeball guestimates, and eliminate the need for redundant and wasteful second and third mechanical surveys. The results of the accurate survey could then be forwarded to a large number of movers for quote, who would quote moving costs based on die highly accurate survey. Given the large number of quotes. the customer could then choose the best deal and award the moving contract, without wasting time on redundant mechanical surveys.

### SUMMARY OF THE INVENTION

The following benefits are provided by the instant Method for Contracting Transportation:

Elimination of time wasted conducting mechanical surveys by moving companies which are not awarded the moving contract.

Elimination of time wasted by the customer on mechanical surveys conducted by moving companies which are not awarded the moving contract.

Highly accurate volume measurement of objects to be moved.

The ability to provide large numbers of moving cost quotes to the customer, which may result in a better deal for the customer.

### BRIEF DESCRIPTION OF THE DRAWINGS

The invention, together with the other objects, features, aspects and advantages thereof will be more clearly understood from the following in conjunction with the accompanying drawings.

Three sheets of drawings are provided. Sheet one contains FIGS. 1 and 2. Sheet two contains FIG. 3. Sheet three contains FIG. 4.

FIG. 1 is a front quarter isometric view of a chair whose volume is being scanned by a scanner in communication with a base station.

FIG. 2 is a front quarter isometric view of a chair whose volume is being scanned by a scanner in communication with a base station.

FIG. 3 is a schematic view of the instant method for contracting transportation.

FIG. 4 is a detail schematic view of the method for contracting transportation where the contractor does not self-award the contract.

### DETAILED DESCRIPTION OF THE PREFERRED EMBODIMENT

The instant method for contracting transportation depends on an accurate measurement of the volume of objects to be transported, such as the contents of a house in the case of a household move. The volume measurement must not only be accurate, but moving companies which are going to bid on moving that volume of objects must have a high confidence level that the volume measurement is accurate.

Once an accurate volume measurement of customer objects to be transported has been made by a contractor, that contractor sends out contractor requests for quote (“RFQs”) to a large number of moving companies. In the preferred embodiment, these could number in the order of one hundred or more contractors. Because the moving companies which receive the contractor RFQ have a high confidence level in the accuracy of the volume measurement, they are willing to quote best price and terms.

The contractor and customer review all moving company bids, and the customer decides on the best one. The contractor then decides whether to exercise his right of first refusal and self-award the contract, or award the transportation contract to the moving company which submitted the best bid. If the contractor awards the contract to the moving company which submitted the best bid, the contractor would be due a commission from that winning moving company.

According to the instant method for contracting transportation, the customer derives the benefit of receiving many more bids than if only two or three moving companies estimated and bid the move. The contractor gains either a commission or a self-awarded transportation contract. The bidding moving companies get to bid on many more moves than they would otherwise, without incurring the cost of performing a mechanical survey on-site to estimate the volume of objects to be moved. Thus, the instant method for contracting transportation is a winning proposition for all concerned.

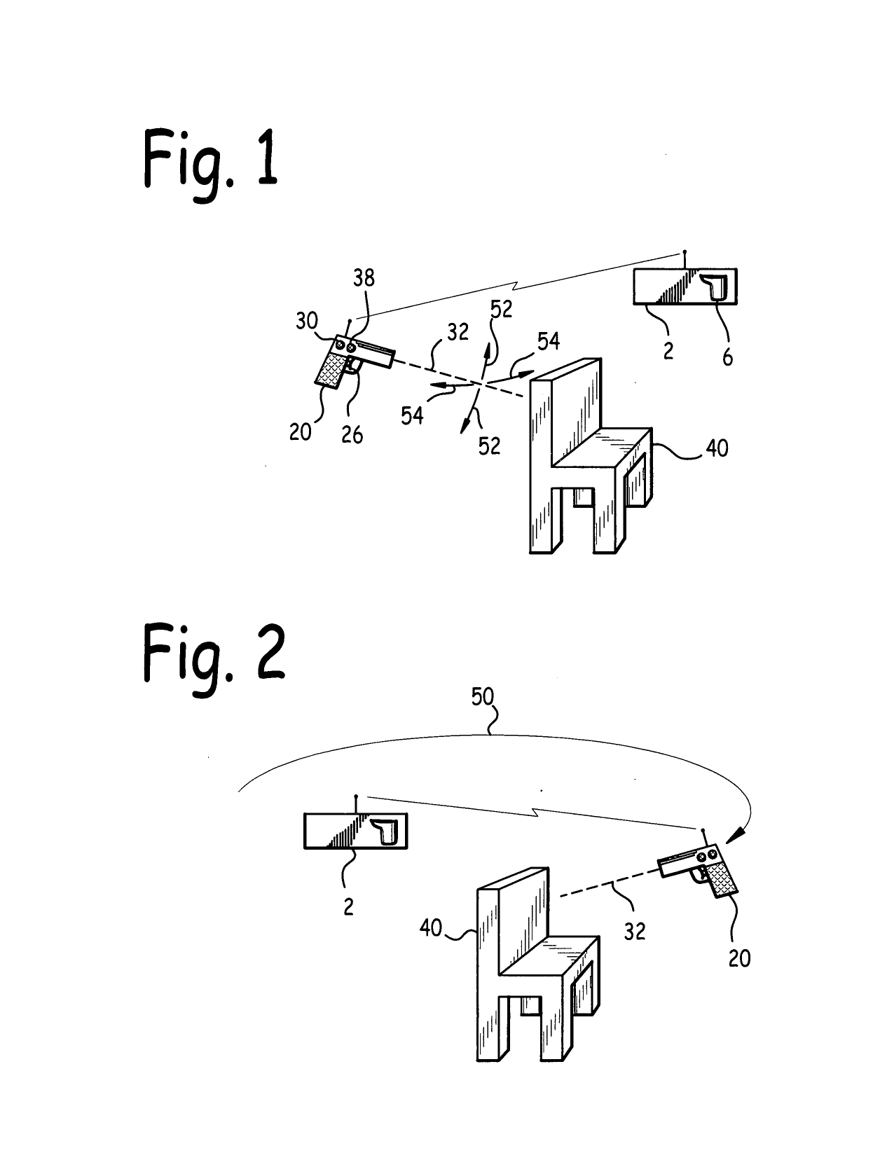

The crucial method step without which the instant method for contracting transportation would not work is the volume measurement step. An Apparatus And Method for Measuring Volumes is taught in companion patent application docket number 0631UR, which along with any other material referenced therein, is hereby incorporated hereinto by reference. A summary of the important accurate volume measurement step is presented below, and should be read with reference to FIGS. 1 and 2.

FIGS. 1 and 2 are front quarter isometric views of a chair 40 whose volume is being scanned by scanner 20 in communication with base station 2. First, scanner 20 is docked in scanner dock 6 on base 2, and INS reset control 30 actuated. This has the effect of establishing a reference point for an inertial navigation system (INS) aboard scanner 20, which may be the origin of a three-dimensional Cartesian coordinate system, or any other point, which may be completely arbitrary.

If base 2 is sitting on a flat surface such as the floor of a room whose contents are to be scanned, scanner 20 may be instructed to disregard anything scanned below a horizontal plane upon which base 2 sits, thus avoiding the inclusion of the volume under the floor of a room whose contents are to be scanned in the volume scanned.

Next, scanner 20 is aimed at an object whose volume is to be scanned, as indicated in FIGS. 5 and 6. Trigger 26 is actuated to commence the scanning function via sensor beam 32, which will continue until trigger 26 is released.

Scanner 20 is moved to several different orientations relative to chair 40, so as to scan chair 40 from all angles, as indicated by arrow 50 in FIG. 2. This has the effect of discounting voids which may exist in the article being scanned, such as the voids between the legs of chair 40. In addition, scanner 20 may be scanned up and down as indicated by vertical arrows 52 in FIG. 5, as well as back and forth horizontally as indicated by horizontal arrows 54, in order to maximize the amount of data points scanned of chair 40 from each perspective.

A central processing unit in base station 2 assembles a model of all points scanned. Of course, the more data points scanned, the more accurate the model. Chair 40 is made up of atoms and molecules, just like everything else which is “solid” in this world. If scanner 20 could scan each atom and molecule comprising chair 40, then the resulting model would be completely accurate. As a matter of practicality, if scanner 40 is capable of scanning up to several million data points per minute, the resulting model will be extremely accurate.

Next the central processing unit (CPU) in base station 2 calculates the volume of chair 40. Where the volume of an entire room-full (or house-full) of furniture is to be calculated, the CPU may maintain a running total of the room and/or house total. After the total volume of a lot of furniture has been scanned and calculated, the chore of quoting a price to move same becomes easy.

An alternate embodiment scanner 20 may include exclusion control 38. Actuation of exclusion control 38 and then scanning the floor and/or walls and/or ceiling of a room has the effect of instructing the CPU to not include these surfaces (or any volumes behind them) in the subsequent volume scan of object(s) resting on the floor or enclosed within the walls and/or ceiling of the room. Once exclusion control 38 is actuated and the floor, walls and/or ceiling of a room have been scanned, exclusion control 38 is de-actuated and a scan of the contents may be initiated.

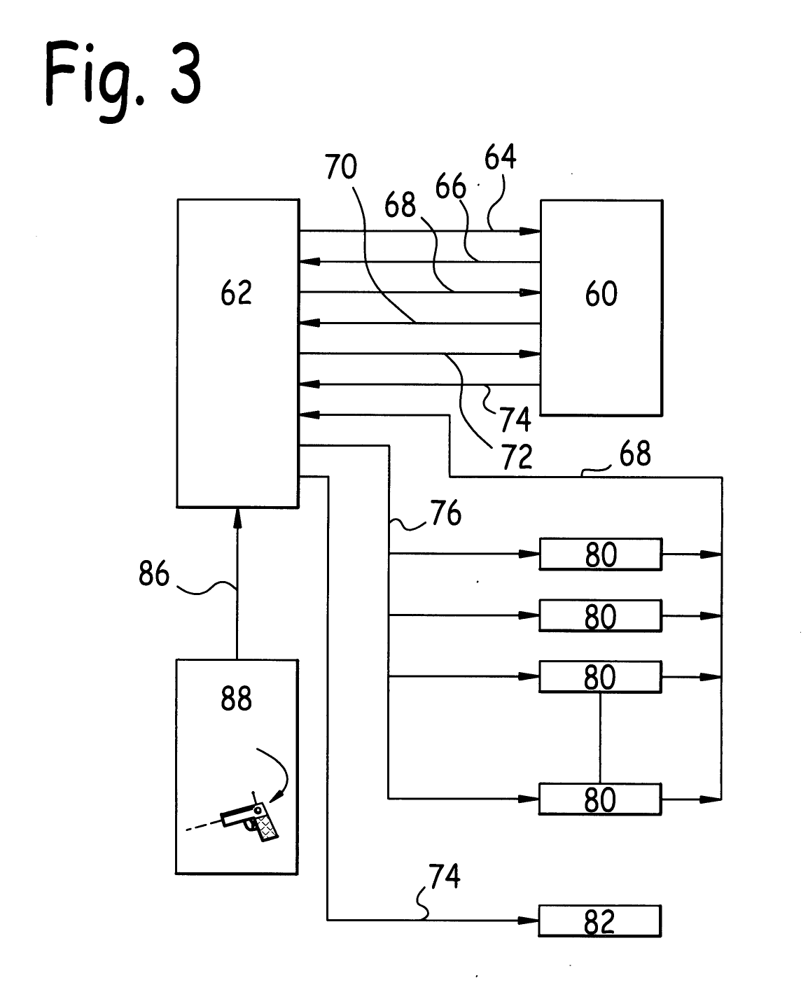

FIG. 3 is a schematic view of the instant method for contracting transportation. Contractor 62 undertakes a marketing effort 64, which may include mailings, advertising, promotional activities, phone book ads, internet marketing efforts, etc. Customer 60 needs some objects transported. Appraised of the services offered by contractor 62, customer 60 submits customer request for quote (RFQ) 86 to contractor 62. The agreement between customer 60 and contractor 62 may include the term that contractor 62 has the right of first refusal to perform the transportation services himself.

Contractor 62 performs accurate volume measurement 88 of the objects customer 60 wants transported, and determines their volume 86, as depicted in FIGS. 1 and 2 and explained above. Contractor 62 then sends contractor RFQ (request for quote) 76 to a large number of moving companies 80. Contractor RFQ 76 includes volume 86 and other move parameters, such as origination and destination of the move, nature of the objects to be transported, time constraints, etc.

At least some moving companies 80 respond by sending moving company quotes 68 to contractor 62. Contractor 62 forwards moving company quotes 68 to customer 60, who reviews the moving company quotes 68 and sends customer decision 70 to contractor 62.

If contractor 62 wishes to exercise his right of first refusal, contractor 62 will self-award the transportation work, and send customer 60 transportation contract 72 for execution. Customer 60 then returns executed transportation contract 74 to contractor 62.

If contractor 62 does not wish to exercise his right of first refusal, contractor 62 will award the transportation work to winning moving company 82, and send customer 60 transportation contract 72 for execution. Customer 60 then returns executed transportation contract 74 to contractor, who forwards it to winning moving company 82.

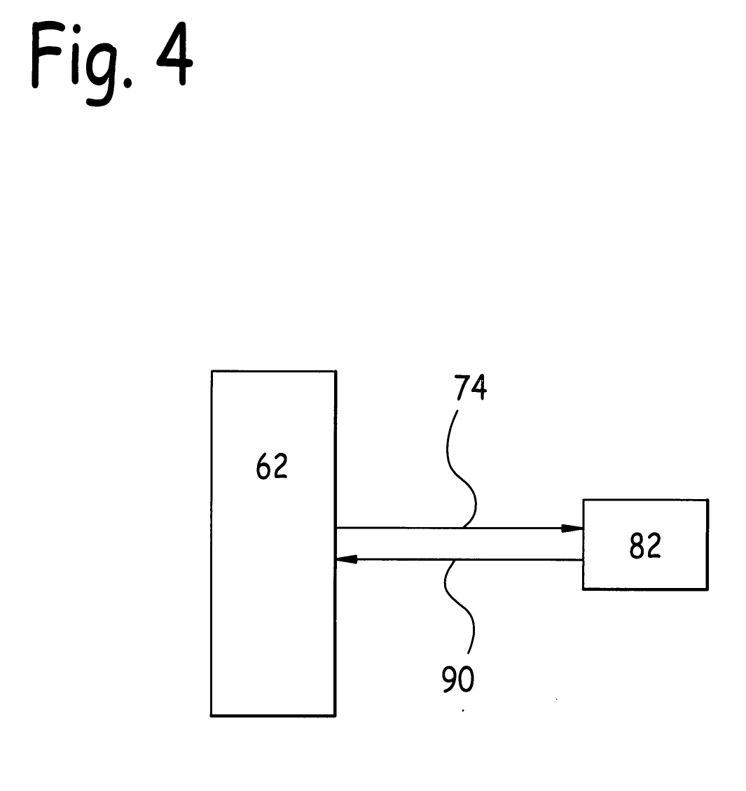

FIG. 4 is a detail schematic view of the instant method for contracting transportation where contractor 62 does not self-award the transportation work, but rather awards the work to winning moving company 82. In such event, contractor forwards executed transportation contract 74, which has been executed by customer 60, to winning moving company 82. Winning moving company 82 then remits commission 90 to contractor 62 for procuring the work for winning moving company 82.

It is intended to fall within the scope of this disclosure that communications between contractor 62 and customer 60, and/or communications between contractor 62 and moving companies 80, may be via the internet, or any other appropriate means, such as fax, telephone, mail, etc.

Thus, the instant method of measuring volume comprises the steps of:

A. A contractor performing marketing effort;

B. A customer submitting a customer RFQ to the contractor;

C. The contractor accurately measuring customer objects to be transported to determine their volume;

D. The contractor sending a contractor RFQ to at least two moving companies,

E. At least one moving company sending a moving company quote to the contractor;

F. The contractor forwarding said at least one moving company quote to said customer;

G. Said customer sending a customer decision on the winning moving company quote to the contractor;

H. The contractor awarding the transportation work to a winning moving company; and

I. The winning moving company remitting a commission to the contractor for procuring the transportation work.

The instant method for contracting transportation may include the further step of the contractor exercising a contractor right of first refusal, and performing the transportation work for the customer for the same price, and under the same terms and conditions, as the winning moving company quote.

The instant method for contracting transportation may include the further step of said contractor and said customer communicating over an internet, and/or contractor 62 and said moving companies communicating over an internet.

The instant method for contracting transportation may comprise the further steps of:

AA. Placing scanner 20 in dock 6 on base 2 and actuating INS reset control 30;

AB. Pointing scanner 20 at an object whose volume is to be scanned;

AC. Actuating trigger 26;

AD. Scanning said object with scanner 20;

AE. Creating a model of said object using data points which have been scanned with scanner 20; and

AF. Calculating a volume of said object.

The instant method for contracting transportation may comprise the steps of scanning by sweeping said scanner vertically up and down, and/or scanning said object by sweeping said scanner horizontally back and forth.

The instant method for contracting transportation may comprise the steps of placing said base station on a floor of a room containing an object to be scanned, and actuating said INS reset control while said base station is on said floor.

The instant method for contracting transportation may comprise the steps of providing an exclusion control, actuating the exclusion control to instruct said CPU to not include surfaces scanned with the exclusion control actuated, and then de-actuating said exclusion control.

While a preferred embodiment of the invention has been illustrated herein, it is to be understood that changes and variations may be made by those skilled in the art without departing from the spirit of the appending claims.

### DRAWING ITEM INDEX

2 base station
6 dock
20 scanner
26 trigger
30 INS reset control
32 sensor beam
38 exclusion control
40 chair
50 arrow
52 vertical arrow
54 horizontal arrow
60 customer
62 contractor
64 contractor marketing effort
66 customer RFQ
68 moving company quotes
70 customer decision
72 transportation contract
74 executed transportation contract
76 contractor RFQ
80 moving company
82 winning moving company
86 volume
88 volume measurement
90 commission

I claim:

1. A method for contracting transportation comprising the steps of:
A. A contractor performing marketing effort;
B. A customer submitting a customer request for quote to the contractor;
C. The contractor accurately measuring customer objects to be transported to determine their volume;
D. The contractor sending a contractor request for quote to at least two moving companies,
E. At least one said moving company sending a moving company quote to the contractor;
F. Said contractor forwarding said at least one moving company quote to said customer; and
G. Said customer sending a customer decision identifying a winning moving company quote to said contractor.

2. The method for contracting transportation of claim 1 comprising the further steps of:
H. Said contractor awarding the transportation work to a winning moving company; and
I. Said winning moving company remitting a commission to said contractor for procuring said transportation work.

3. The method for contracting transportation of claim 1 comprising the further steps of said contractor exercising a contractor right of first refusal, and said contractor performing the transportation work for said customer at a lowest price quoted by said moving companies.

4. The method for contracting transportation of claim 1 comprising the further step of said contractor and said customer communicating over an internet.

5. The method for contracting transportation of claim 1 comprising the further step of said contractor and said moving companies communicating over an internet.

6. The method for contracting transportation of claim 1 comprising the further steps of:
AA. Placing a scanner in a dock on a base and actuating an inertial navigation system reset control;
AB. Pointing said scanner at an object whose volume is to be scanned;
AC. Actuating a trigger;
AD. Scanning said object with said scanner;
AE. Creating a model of said object using data points which have been scanned with said scanner; and
AF. Calculating a volume of said object.

7. The method for contracting transportation of claim 6 comprising the further steps of scanning by sweeping said scanner vertically up and down, and/or scanning said object by sweeping said scanner horizontally back and forth.

8. The method for contracting transportation of claim 6 comprising the further steps of placing said base station on a floor of a room containing an object to be scanned, and actuating said inertial navigation system reset control while said base station is on said floor.

9. The method for contracting transportation of claim 6 comprising the further steps of providing an exclusion control, actuating said exclusion control to instruct said central processing unit to not include surfaces scanned with said exclusion control actuated, and then de-actuating said exclusion control.

10. A method for contracting transportation comprising the steps of:
A. A contractor performing marketing effort;
B. A customer submitting a customer request for quote to the contractor;
C. The contractor accurately measuring customer objects to be transported to determine their volume;
D. The contractor sending a contractor request for quote to at least two moving companies,
E. At least one said moving company sending a moving company quote to the contractor;
F. Said contractor forwarding said at least one moving company quote to said customer;
G. Said customer sending a customer decision identifying a winning moving company quote to said contractor.
H. Said contractor awarding the transportation work to a winning moving company; and
I. Said winning moving company remitting a commission to said contractor for procuring said transportation work.

11. The method for contracting transportation of claim 10 comprising the further step of said contractor and said customer communicating over an internet.

12. The method for contracting transportation of claim 10 comprising the further step of said contractor and said moving companies communicating over an internet.

13. The method for contracting transportation of claim 10 comprising the further steps of:
AA. Placing a scanner in a dock on a base and actuating an inertial navigation system reset control;
AB. Pointing said scanner at an object whose volume is to be scanned;
AC. Actuating a trigger;
AD. Scanning said object with said scanner;
AE. Creating a model of said object using data points which have been scanned with said scanner; and
AF. Calculating a volume of said object.

14. The method for contracting transportation of claim 13 comprising the further steps of placing said base station on a floor of a room containing an object to be scanned, and actuating said inertial navigation system reset control while said base station is on said floor.

15. The method for contracting transportation of claim 13 comprising the further steps of providing an exclusion control, actuating said exclusion control to instruct said central processing unit to not include surfaces scanned with said exclusion control actuated, and then de-actuating said exclusion control.

16. The method for contracting transportation of claim 10 comprising the further steps of said contractor sending a transportation contract to said customer, said customer executing said transportation contract and returning the executed transportation contract to said contractor, and said contractor forwarding said executed transportation contract to said winning moving company.

17. A method for contracting transportation comprising the steps of:
A. A contractor performing marketing effort;
B. A customer submitting a customer request for quote to the contractor;
C. The contractor accurately measuring customer objects to be transported to determine their volume;
D. The contractor sending a contractor request for quote to at least two moving companies,
E. At least one said moving company sending a moving company quote to the contractor;
F. Said contractor forwarding said at least one moving company quote to said customer;
G. Said customer sending a customer decision identifying a winning moving company quote to said contractor;
H. Said contractor exercising a contractor right of first refusal; and
I. Said contractor performing said transportation work for said customer.

18. The method for contracting transportation of claim 17 comprising the further step of said contractor and said customer communicating over an internet.

19. The method for contracting transportation of claim 17 comprising the further step of said contractor and said moving companies communicating over an internet.

20. The method for contracting transportation of claim 17 comprising the further steps of:
AA. Placing a scanner in a dock on a base and actuating an inertial navigation system reset control;
AB. Pointing said scanner at an object whose volume is to be scanned;
AC. Actuating a trigger;
AD. Scanning said object with said scanner;
AE. Creating a model of said object using data points which have been scanned with said scanner; and
AF. Calculating a volume of said object.

21. The method for contracting transportation of claim 20 comprising the further steps of placing said base station on a floor of a room containing an object to be scanned, and actuating said inertial navigation system reset control while said base station is on said floor.

22. The method for contracting transportation of claim 20 comprising the further steps of providing an exclusion control, actuating said exclusion control to instruct said central processing unit to not include surfaces scanned with said exclusion control actuated, and then de-actuating said exclusion control.

23. The method for contracting transportation of claim 17 comprising the further steps of said contractor sending a transportation contract to said customer, and said customer executing said transportation contract and returning the executed transportation contract to said contractor.
